(19) United States
(12) Patent Application Publication
(10) Pub. No.: US 2008/0154920 A1
(43) Pub. Date: Jun. 26, 2008

(54) Method and system for managing web content linked in a hierarchy

(75) Inventor: Aloke Guha, Louisville, CO (US)

Correspondence Address: Trellis Intellectual Property Law Group, PC, 1900 EMBARCADERO ROAD, SUITE 109, PALO ALTO, CA, 94303, US

(73) Assignee: COPAN Systems, Inc., Longmont, CO (US)

(21) Appl. No.: 11/644,169

(22) Filed: Dec. 22, 2006

(51) Int. Cl. G06F 17/30

(52) U.S. Cl. 707/100; 707/E17.044

(57) ABSTRACT

A method and system for managing web content linked in a web page hierarchy, are provided. The method includes determining when a first web content, stored in a first storage medium, is accessed. Further, the method includes determining a second web content, linked to the first web content. The second web content may be accessible through a web page that includes the first web content. Furthermore, the method includes determining a second storage medium that is storing the second web content. When a portion of the second web content is requested, the second storage medium powers up from a lower power mode of operation to a power mode of operation that is higher than the lower power mode, such that the second web content can be accessed from the second storage medium quicker than if the second storage medium had remained in the lower power mode of operation.

### BACKGROUND

Particular embodiments relate in general to computer storage systems, and more specifically, to managing and storing web content for access.

A large amount of data is available on the Internet in the form of the websites, and more data is added every day. The data available on these websites is stored on storage systems. Much of the data is archival in nature, in that it is written once, infrequently changed, and accessed occasionally. Given the nature of access, storing this type of web content on archival storage enables freeing primary storage system to accommodate additional data to enable data to be restored if it is lost, destroyed or corrupted; to improve system efficiency for data that is accessed infrequently, as well as for other reasons such as lower cost.

Archival storage systems are usually larger provide lower performance and cost less than the primary storage system. For example, a tape drive, a slower disk drive, an optical drive, etc., are used as archival storage systems. However, the archival storage systems can be designed to cost less per storage unit and consume less power. Care must be taken to create an efficient storage system so that storage and retrieval between the primary and archival storage systems does not conflict with the expected performance of an online computer system that the archival storage system is designed to support. Most archival storage systems using slower media or devices that can have high latency. This implies that the time required to spin up a drive and make the data available to the user is high compared to what is acceptable for most online access. Therefore, such archival storage systems based on slow removable or offline media are not suitable for online access to data. For example, a user may log on to a particular website and due to the large latency of the storage systems that use slow media, the website may not load with the expected response time on the user's computer system. As a result of the delay in loading the website, the user may abandon the website. Hence, data residing on archival storage systems with high latency are not suitable for online access.

### SUMMARY

A method for managing web content linked in a hierarchy according to a web page structure is provided, in accordance with various embodiments of the invention. The method includes determining a time of access of a first web content. The first web content is stored in a first storage medium and is linked to a second web content in the hierarchy. The second web content is accessible through a web page that includes references to the first web content. Further, the method includes determining the second storage medium that stores the second web content. Furthermore, the method includes powering up the second storage medium from a lower power mode of operation to a power mode of operation. This power mode is higher than the lower power mode, such that the second web content can be accessed from the second storage medium quicker than if the second storage medium remained in the lower power mode of operation when a portion of the second web content is requested.

Various embodiments of the present invention provide a storage system for managing web content linked in a hierarchy, according to a web page structure. The web content is linked in a hierarchy according to a web page structure. The storage system includes a first storage medium controller, which determines a time of access of a first web content. The first web content is stored in a first storage medium. Further, the storage system includes a second storage medium controller. The second storage system determines a second web content that is linked to the first web content in the hierarchy. The second web content is accessible through a web page that includes references to the first web content. Further, the storage system includes a power manager. The power manager is coupled to the first storage medium controller and the second storage medium controller to power up the second storage medium from a lower power mode of operation to a higher power mode of operation. The power mode of operation is higher than the lower power mode, ensuring that the second web content can be accessed from the second storage medium, faster than if the second storage medium had remained in the lower power mode of operation when a portion of the second web content is requested.

### BRIEF DESCRIPTION OF THE DRAWINGS

FIG. 1 illustrates a block diagram of a storage system, in accordance with various embodiments.

FIG. 2 illustrates a block diagram of a media management system for managing web content linked in a hierarchy, in accordance with an embodiment.

FIG. 3 illustrates an example of a web hierarchy, in accordance with an embodiment.

FIG. 4 illustrates a flowchart depicting a method for managing web content linked in a hierarchy, according to a web page structure, in accordance with various embodiments.

FIGS. 5 and 6 illustrate a flowchart depicting a method for managing web content linked in a hierarchy, according to a web page structure, in accordance with an embodiment.

### DETAILED DESCRIPTION OF DRAWINGS

Embodiments of the present invention provide a method, system and computer program product for accessing web content linked in a hierarchy in an archival storage system. The archival storage system is used for archiving web content from a primary storage system in a secondary storage system, retrieving various files from the secondary storage system to a primary storage system, and managing them. Further, a media management system of the archival storage system can manage various users of the archival storage system.

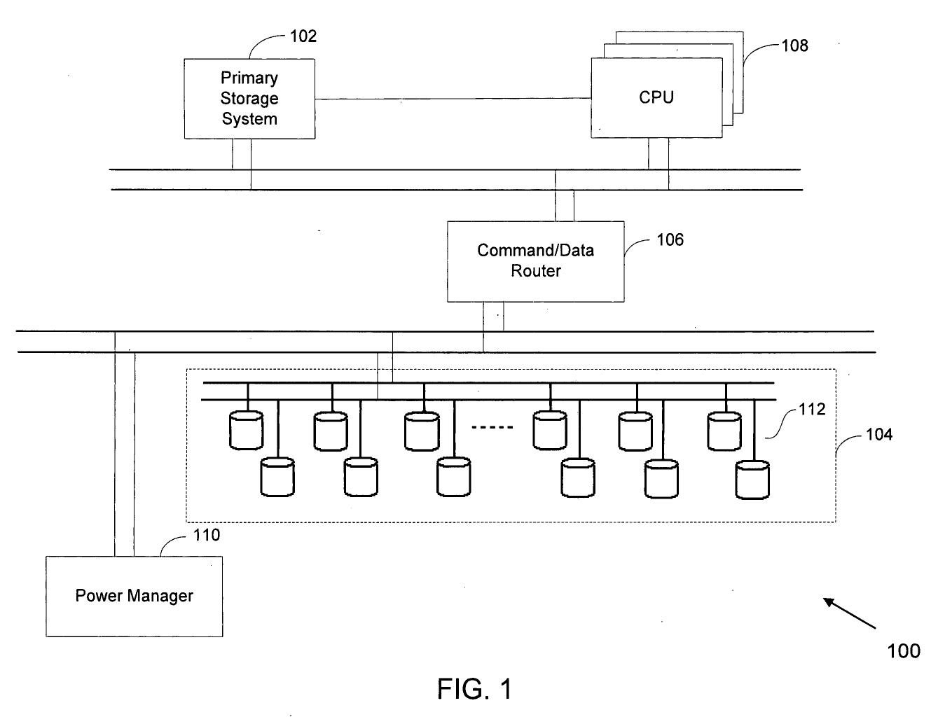

FIG. 1 illustrates a block diagram of a storage system 100, in accordance with various embodiments. Particular embodiments include features for enabling data archiving in computer systems. The storage system 100 includes a primary storage system 102, a secondary storage system 104, a command router 106, a Central Processing Unit (CPU) 108, and a power manager 110.

The storage system 100 enables a user of the storage system 100 to store data units from the primary storage system 102 in the secondary storage system 104. The data units stored in the secondary storage system 104 may be one or more data units containing information or data. In an embodiment, the data units may be web content. Further, the secondary storage system 104 may include one or more data drives that can be in a powered on or in a lower-powered mode of operation at a given point of time. The data units present in the primary storage system 102 can be archived in the secondary storage system 104. The secondary storage system 104 also includes a plurality of secondary storage media 112. The one or more disk drives in the plurality of the secondary storage media 112 can be in a powered-on mode or in a lower power mode of operation. The one or more disk drives of the plurality of the secondary storage media 112 containing the data units can be powered on from a lower power mode of operation when the user of the storage system 100 retrieves the data units from the plurality of the secondary storage media 112. The one or more disk drives can be powered on or powered down by the power manager 110. The power manager 110 powers up one or more drives of the secondary storage media 112 from a lower power mode of operation to a powered mode of operation when the data is accessed by the user. When the one or more drives of the secondary storage media 112 are powered up, the second web content can be accessed faster than if the secondary storage medium 112 had remained in the lower power mode of operation. Further, the power manager 110 may be capable of powering down one or more drives of the secondary storage medium 112 to a lower power level when the one or more drives are not accessed by the user.

In an embodiment, a disk drive in the secondary storage system 104 may be in a lower power mode of operation, as compared to another disk drive in the secondary storage system 104. For example, a first secondary storage medium may be spinning at a lower speed or may be idle, as compared to the second secondary storage medium. Further, the lower power mode of operation may include a powered off state or standby state. Access to the data units from the secondary storage system 104 in the lower power mode of operation may be slower than when the second storage medium is powered on.

The storage system includes the CPU 108, which maintains the metadata of the data units stored at the secondary storage system 104. This metadata may include one or more attributes pertaining to the data units stored in the plurality of secondary storage media 112.

The command router 106 can interpret the commands received at the storage system 100. The command router 106 is an interface between the CPU 108 and the secondary storage system 104 and can interpret the one or more commands sent to the storage system 100 through the CPU 108. The command router 106 then carries out various operations on the secondary storage system 104, based on the commands provided to the storage system 100. Further, the command router 106 may be used to move data units from the primary storage system 102 to the secondary storage system 104.

The storage system 100 can use the power manager 110 to carry out various operations on the data units stored in the one or more disk drives of the secondary storage system 104. The user of the storage system 100 can carry out different operations, such as managing data stored in the plurality of secondary storage media 112. The data can correspond to one or more links in a web hierarchy. The power manager 110 can power up the data drive that is storing the web content requested by the user from a lower power mode of operation to a power mode of operation.

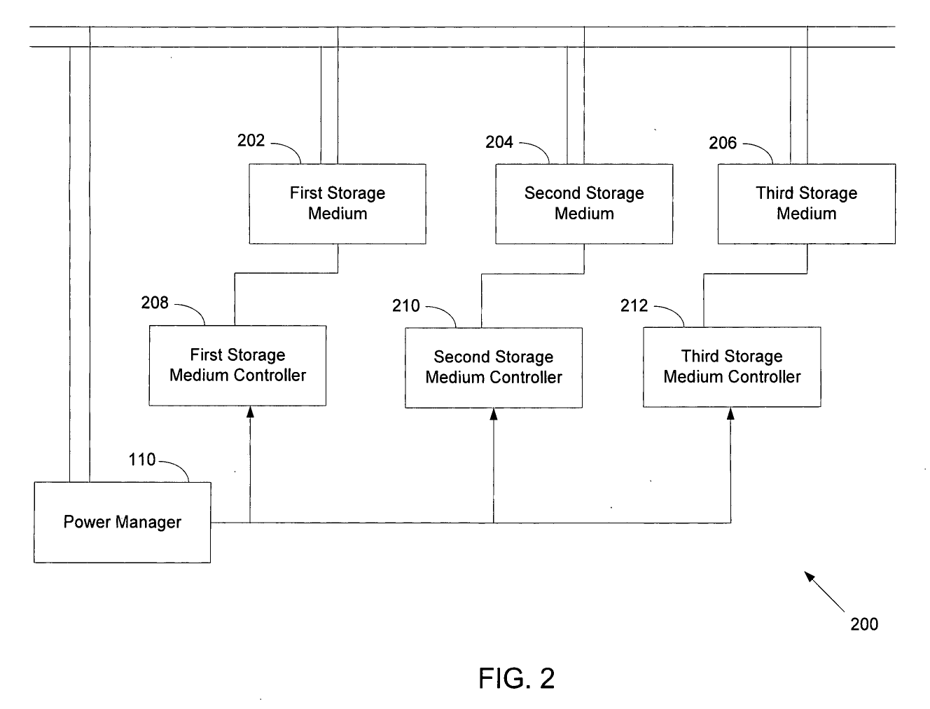

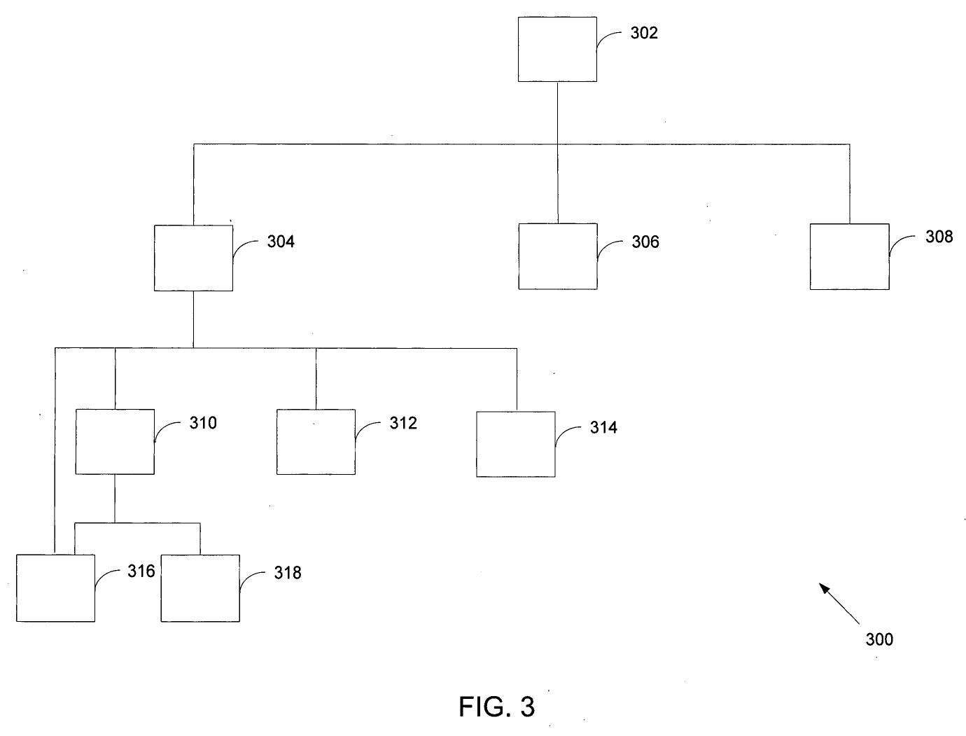

FIG. 2 illustrates a block diagram of a media management system 200 for managing web content linked in a hierarchy, in accordance with an embodiment. The hierarchy includes placing information in a nested structure. Therefore, the web hierarchy provides a convenient way for the user to find the required web content. The web hierarchy is explained further in conjunction with FIG. 3. The media management system 200 includes a first storage medium 202, a second storage medium 204, and a third storage medium 206. The first storage medium 202 can store a first web content. An example of the first web content can be a home page of a website, and the like. The first web content is linked to one or more second web content in the web hierarchy structure. The one or more second web content may be stored in one or more disk drives of the second storage medium 204. Examples of the second web content can be an image, an audio file, a video file on the page, and the like. The first web content has to be accessed before the second web content, which can only be accessed through the web page that references the first web content.

In an embodiment, the second web content is one or more levels below the first web content in the hierarchy. For example, in the case of a website, a first web content may be a link on a home page of a website, and the second web content may be a hyperlink that is also linked to the link on the home page. In an embodiment, the second storage medium may be in a lower power mode of operation. So, access to the second web content from a second storage medium 204 may be slower than when the second storage medium 204 is powered on. For example, a user may make a request for web content that is stored in the second storage medium, which is in the lower power mode of operation.

Further, the media management system 200 may include a third storage medium 206. The third storage medium 206 that includes a third web content may be in a lower power mode of operation, as compared to the first storage medium 202. The third web content may be below the first web content in the web content hierarchy. When the first web content is accessed by the user, the third storage medium 206 is powered up to a power mode of operation from a lower power mode of operation.

In an embodiment, the third web content may be accessed in a plurality of ways, such that when the first web content is accessed, the third storage medium 206 is given enough time to power on. Thus, the third web content may be accessed from a powered on drive if it is requested (i.e., a user navigates from the first web content to second web content and then request the third web content). Further, the third web content may not be accessible from the first web content in the web content hierarchy. Therefore, the third storage medium 206 may be placed in a lower power mode of operation. Also, the third web content may be a number of levels below the first web content such that the user may have to navigate through a number of web pages to request the third web content. Therefore, the third storage medium 206 may be powered down to a lower power level.

The media management system 200 can be used to carry out various operations on the web content stored in the plurality of storage media in the secondary storage system 104. Examples of such operations can include determination of the structure of the web content that is arranged in a hierarchy and accessing various levels of hierarchy, etc., based on the web content accessed by the user. Further, the media management system 200 can also perform various other operations such as archiving data from the primary storage system 102 on to the secondary storage system 104, retrieving data from the secondary storage system 104, etc., based on I/O requests made by the user.

Further, the CPU 108 of the storage system 100 may include the first storage medium controller 208, a second storage medium controller 210, and a third storage medium controller 212. The first storage medium controller 208 determines when the first web content is to be accessed. The first storage medium controller 208 is coupled to the second storage medium controller 210. In an embodiment, the second storage medium 204 may be in a Redundant Array of Independent Volumes (RAIV) system. The data that resides on RAIV is organized such that it provides information about the data on the set of disk drives. Further, RAIV system facilitates caching of the data that is to be written or read from disk drives, in the secondary storage system 104, that are not powered on. For storing the data, the RAIV ‘serializes’ a set of data disk drives together with a fixed parity drive. The data can be accessed from the RAIV system by accessing one or more data storage drives. Because RAIV allows access to data from as few as a single drive at a time, it reduces the spin-up latency in accessing the data. Therefore, the delay in loading the web content stored on the second storage medium 204 on the drive is minimized. Hence, the second web content can be accessed readily by the user. A detailed explanation of the RAIV system is present in the U.S. Pat. No. 7,035,972, titled ‘Method and Apparatus for Power-Efficient High-Capacity Scalable Storage System’, which is incorporated here by reference, as if set forth in this document in full, for all purposes.

The media management system 200 also includes the power manager 110. The power manager 110 may be coupled to the first storage medium controller 208, the second storage medium controller 210, and the third storage medium controller 212. The power manager 110 powers up the second storage medium 204 from a lower power mode of operation to a higher powered mode of operation when it is determined that the first web content has been accessed by the user. When the second storage medium 204 is powered up, the second web content can be accessed faster than if the second storage medium 204 had remained in the lower power mode of operation. Further, the power manager 110 may be capable of powering down the third storage medium 206 to a lower power level when the third storage medium 206 is several levels away from the first web content in the web content hierarchy.

The second storage medium controller 210 determines the second storage medium 204 that stores the second web content. When the first web content is accessed by the user, the first storage medium controller 208 informs the power manager 110. Further, based on the web hierarchy, the power manager 110 may direct the second storage medium controller 210 to power on the second storage medium 204.

The web hierarchy may also include a third web content that is not accessible from the first web content. The third web content may be stored in the third storage medium 206, which may be coupled to a third storage medium controller 212. The third storage medium controller 212 determines the third storage medium 206. The third storage medium controller 212 may be coupled to the first storage medium controller 208 and the second storage medium controller 210. When the user accesses the first web content, the second storage medium controller 210 and the third storage medium controller 212 determine the second web content and the third web content, respectively, which are linked to the first web content.

The power manager 110 can power down the third storage medium 206 to a lower power mode when the third web content is not accessible from the first web content, based on the web hierarchy. The power manager 110 can power up the third storage medium 206 from a lower power mode of operation to a power mode of operation that is higher than the lower power mode when the third web content is accessible from the first web content within the specified time period.

In an embodiment, the media management system 200 for managing the storage system 100, which may be based on a power managed Redundant Array of Independent Disks (RAID) system or a power managed Massive Array of Independent Disks (MAID) system, is provided. In a power managed storage system only a limited number of storage devices are powered on at a time, according to the maximum permissible power consumption or “power budget.” Power-managed RAID systems are described in, for example, U.S. Pat. No. 7,035,972, titled ‘Method and Apparatus for Power-Efficient High-Capacity Scalable Storage System’, which is incorporated herein by reference, as if set forth in this document in full for all purposes.

FIG. 3 illustrates an exemplary web hierarchy 300, in accordance with various embodiments. The web hierarchy 300 may consist of a web content 302, which may be linked to one or more first-level web content. Examples of the first-level web content may be web content 304, web content 306, and web content 308. Further, the first-level web content may be linked to one or more second-level web content. For example, the web content 304 may be linked to web content 310, web content 312, and web content 314. The second-level web content may be linked to one or more third-level web content. For example, the web content 310 may be linked to web content 316 and web content 318. In an embodiment, first-level web content may be linked to third-level web content. For example, the web content 304 may be linked to the web content 318.

It would be apparent to a person ordinarily skilled in the art that the web hierarchy, as depicted in FIG. 3, is purely exemplary, and numerous other structures of the hierarchy are possible. In an embodiment, the web content stored in one or more storage media of the storage system 100 may be adapted, based on the changes in the web page structure.

As shown in FIG. 3, the first storage medium 202 may store the first web content. The first storage medium 202 is in an ‘always on’ mode. The second web content 310 is stored in a second storage medium 204 and is linked to the first web content 304. Therefore, when the user accesses the first web content 302, the web content 304 may be available to him/her. The second web content 310 has to be accessed before the third web content 316, i.e., to access the third web content 316, a sequential traversing of the web hierarchy is required. This implies that a longer access delay is allowed for the third web content 316 to load, as compared to the access delay allowed for the second web content 310. Therefore, the second storage medium 204, storing the second web content, may be powered up from a lower power mode of operation to a higher power mode of operation.

The third web content 316 that is linked to the first web content 304 is stored in the third storage medium 206, which may be in a lower power mode of operation. However, when it is determined that the third web content 316 is accessible within a specified time period, the third storage medium 206 may be powered on to a power mode of operation that is higher than the lower power mode of operation.

In an embodiment, the web hierarchy may include parent content. The parent content may include a parent link. Further, the web content linked to the parent content may be considered to be child content. Each child content may include a child link. For example, web content 302 may be a parent content. The parent content may be linked to one or more first-level child content. The web content stored at the child's contents is called child links because the links to these contents are accessible from the parent link. Furthermore, the first-level content may be linked to one or more second level content.

In one embodiment, a storage medium storing the parent link may be in an ‘always power on’ mode. Therefore, when a parent link is accessed by a user, the parent link is readily available to the user. Also, some of the storage media for storing child links may also be powered on. This ensures that a user can access web content from the parent link. One or more storage media storing one or more child links at lower levels may then be powered on from a lower power mode of operation to a power mode of operation. The power mode of operation is higher than the lower power mode of operation. Therefore, the child links that are linked to the parent link may be readily accessible to the user.

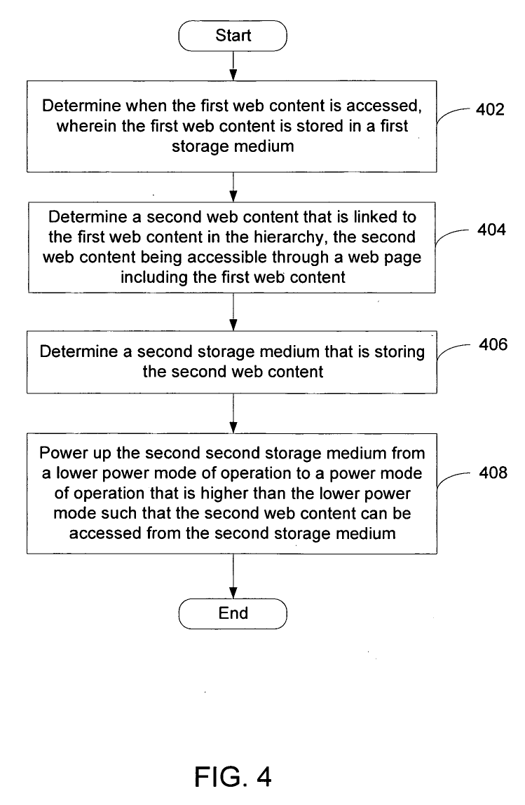

FIG. 4 illustrates a flowchart depicting a method for managing web content linked in a hierarchy, in accordance with various embodiments. The web content may be stored on the plurality of secondary storage media 112. The plurality of the secondary storage media 112 includes one or more disk drives that may be in a powered on or a lower power mode of operation at a given time. The CPU 108 of the storage system 100 includes a metadata file that comprises information pertaining to the web content stored on the plurality of the secondary storage media 112. The data or information relating to the web content may include one or more attributes of data units such as a web address of the web content, a disk drive on which the web content is stored, etc.

The one or more web content that is stored in the plurality of the secondary storage media can be accessed through the storage system 100. Some of the secondary storage media may be in a lower power mode of operation. The storage system 100 may allow the web content to be accessed by using the metadata stored in the storage system 100. Conventionally, immediate accessing of the web content in the third storage medium 206 in a lower power mode of operation was not possible. However, various embodiments of the present invention provide immediate access to web content stored at the third storage medium 206 that is in a lower power mode of operation. When the user wishes to access a web content stored at the third storage medium 206 that is in the lower mode of operation, it may be cached on the first storage medium 202 so that the user may get an immediate access of the web content.

The method of managing web content linked in a hierarchy is explained in FIG. 4. At step 402, it is determined when the first web content is to be accessed. The first web content is stored in the first storage medium 202. At step 404, a second web content is determined that is linked to the first web content in the hierarchy. The first web content may have to be accessed before the second web content is accessible, since the second web content is accessible through a web page that includes the first web content. The second web content may be one or more levels below the first web content in the hierarchy. The information pertaining to the levels of the web content is determined at the storage system 100. The information may include information relating to the web content present in the second storage medium 204.

At step 406, the second storage medium 204 that is storing the second web content is determined. In an embodiment, the second storage medium 204 may be determined by the second storage medium controller 210. The second storage medium 204 may be in a lower power mode of operation than the first storage medium 202. The first storage medium 202 may be in a powered-on state and the second storage medium 204 may be in a lower power mode of operation at the time when the information about the web content is determined. Further, the second storage medium 204 may be in a lower power mode such that access to the web content is slower than if it were in the powered-on state.

At step 408, the second storage medium 204 may be powered up from a lower power mode of operation to a higher power mode of operation. Therefore, the second web content may be accessed from the second storage medium 204. The secondary storage system 104 may store the web content on the first storage medium 202. Further, the sub-levels of the web content may be stored on the plurality of second storage media 204 that may be in a lower power mode of operation at the time the web content is accessed. The storage system 100 may identify the plurality of storage media that are in the lower power mode of operation and may power on the plurality of second storage medium 204 to access the web content. In an embodiment, the second storage medium 204 may be powered on by the power manager 110. When the second storage medium is powered on, the web content stored on the second storage medium may be accessed readily by the user. This may reduce any delay while loading the web content. Therefore, the user may not need to wait while the web content is being loaded.

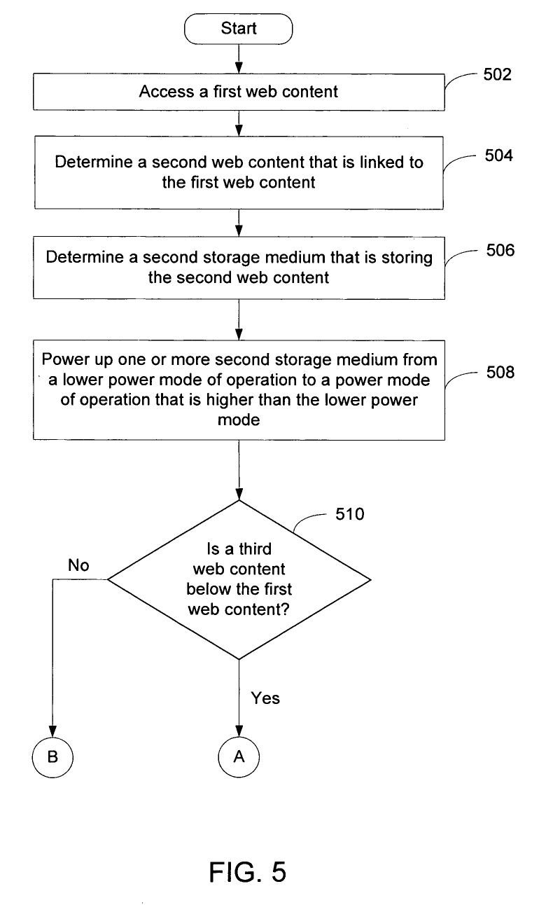

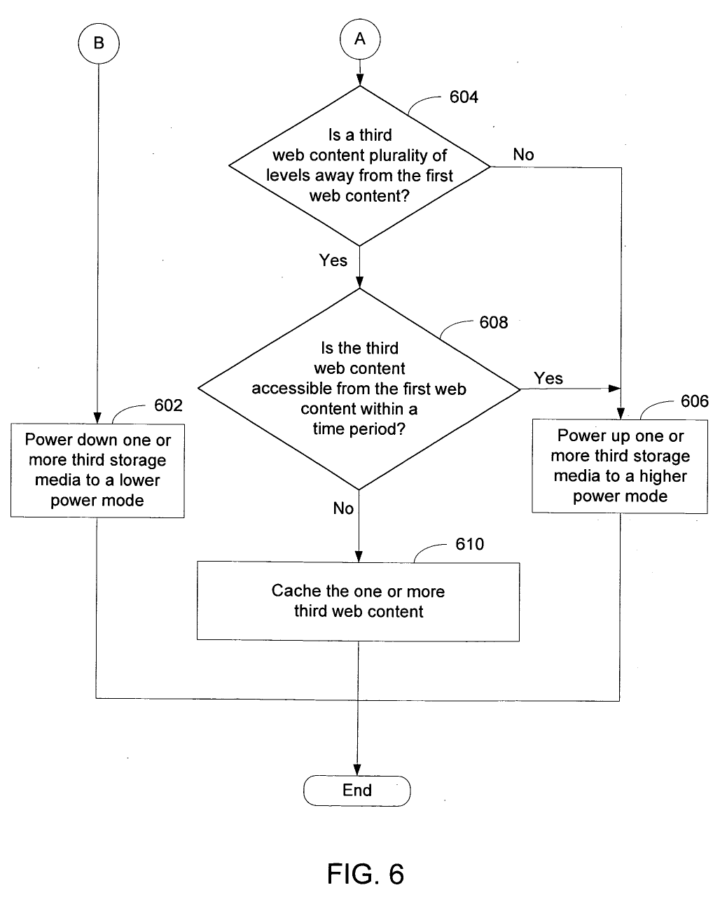

FIGS. 5 and 6 illustrate a flowchart depicting a method for managing web content that is linked in a hierarchy, according to a web page structure, in accordance with an embodiment. The web content can be structured in a hierarchical model, a tree structure, etc. For the sake of this description, a hierarchical structure of the web content is considered, as explained in FIG. 3. The web hierarchy 300 includes a first web content that can be linked to a plurality of web content, which are available at one or more levels. The plurality of web content may include a plurality of second-level web content that are linked to the first-level web content. Further, the second-level web content can be linked to one or more third-level web content.

The first-level web content is stored in the first storage medium 202. Further, the plurality of second-level web content can be stored in the plurality of second storage media 204, depending on which storage devices need to be powered on. In an embodiment, the second storage medium 204 can be in a Redundant Array of Independent Volumes (RAIV) system. In the RAIV system, data is written to the disk drives sequentially. The RAIV enables spinning up of single drives to reduce spin-up delays and increase the number of drives that can be powered within the constraints of a limited power budget. Therefore, the delay in loading the web content is minimized, since the delay in the spinning up of the single disk is lower than in a full set of multiple disks. Hence, the first-level web content may be stored in the first storage medium 202, and the higher level web content, for example, the second web content, may be retrieved by sequentially powering on the next drive in the second storage medium 204.

The method for managing web content in a hierarchy is illustrated in FIGS. 5 and 6. At step 502, the user of the storage system 100 can access the first web content, which can be stored in the first storage medium 202. A second web content that is linked to the first web content is determined at step 504. The second web content is stored in one or more second storage media 204. The one or more second storage media 204 are determined at step 506. In an embodiment, the one or more second storage media 204 can be in a RAIV system, as discussed above.

When it is determined that the one or more second storage media 204 are storing the second web content, the one or more second storage media 204 are powered up from a lower power mode of operation to a power mode of operation that is higher than the lower power mode. In an embodiment, the power mode of operation that is higher than the lower mode of operation includes a power on mode. Therefore, the one or more second storage media 204 that is storing the one or more second web content is powered on at step 508. The second web content may be accessed without moving it to another storage medium. Conventionally, to access the second web content, it had to be moved to the primary storage system 102.

Conventionally, the first web content had to be stored in the first storage medium with a fast memory. The second web content linked to the first web content had to be stored on a second storage medium, and another web content linked to the first web content had to be stored on a separate storage device. In order to access the second web content, the second web page had to be transferred from the second storage medium to the fast memory. Further, the other web content stored at the storage device had to be transferred from the storage device to the second storage medium. However, in the present invention, the first web content and the second web content are stored at the first storage medium 202 and the second storage medium 204. The second web content may be accessed by powering on the second storage medium 204 that is storing the second web content. Therefore, the present invention eliminates the need for transferring the web content from one storage medium to another.

At step 510, it is determined whether the third web content is below the first web content in the web hierarchy. If it is determined at step 512 that the third web content is not accessible from the first web content, the one or more third storage media that are storing the third web content may be powered down to a lower power level at step 602. However, if it is determined that the third web content is below the first web content in the web content hierarchy, at step 510, it is ascertained at step 604 whether it is a certain number of levels below the first web content. The certain number of levels may be determined based on time required to access web content. The time required to access web content can be determined, based on the latency of one or more storage media. For example, let us assume that a user requires three seconds to react to web content and find a link. Further, the latency or spin-up delay for one or more storage devices may be assumed to be 15 seconds. In such a case, five levels of storage media need to be powered on. The web content stored at the level 6 storage device may be retrieved from the lower power storage medium during that period.

If it is determined at step 604 that the third web content is not the certain number of levels below the first web content, the one or more third storage media 206 are powered up from a lower power mode of operation to a power mode of operation that is higher than the lower power mode at step 606. For example, it may be determined that 6 levels of storage devices may be powered on within the time period. Therefore, the web content stored in the storage media that are within 6 levels may be powered on. However, if it is determined at step 604 that the third web content is a plurality of levels away from the first web content, it is ascertained whether the third web content is accessible from the first web content within a specified time period at step 608.

If it is determined at step 608 that the third web content is not accessible from the first web content within the specified time period, the one or more third storage media 206 may be cached on the first storage medium 202 at step 610. However, if it is determined at step 608 that the third web content is accessible from the first web content within the specified time period, the one or more third storage media are powered up from a lower power mode of operation to a higher power mode of operation at step 606.

In an embodiment, the one or more drives of the second storage media 204 may be kept ‘always powered on’. The one or more always powered on drives of the second storage media 204 may be used to cache one or more web content that are frequently accessed. Further, the web content that include large data objects may be stored on second storage media 204. For example, audio files, media files and graphic files may be stored on always powered on second storage media 204. Therefore, the accessed one or more third web content may be cached on one or more always on second storage drives at step 610. Further, the third storage medium 206 may be in a lower powered state. In another embodiment, HyperText Transfer Protocol (HTTP) protocols may be used to fill in forms in the cached web content. For example, in the cached web pages, while large objects are read in the powered off third storage medium 206 and read as the current web pages are displayed.

Various embodiments of the method and system for managing web content linked in a hierarchy, according to a web page structure, are provided. The method has an advantage that while the user is navigating the web pages, the time delay in the spinning up of a storage medium from a lower powered mode to a higher power mode of operation can be masked. Further, large web content such as an audio or media file, a graphics image, etc., can be kept on higher power storage media. This has the advantage that the penalty of a spin up of a storage medium may be reduced. Another advantage is that the method does not require the web content to be transferred to another storage medium. The web content may be stored on one or more lower-powered data drives in the second storage media that may be powered on when the web content is requested. In an embodiment, one or more drives of the second storage media may be kept always powered on, so that the most frequently accessed web content can be cached on the always powered on drives.

The storage system 100 described in particular embodiments, or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the particular embodiments. The functions described herein can be achieved in hardware, software, or a combination of both, as desired. Specific programming languages, statements, syntax or other details of the software or software description can be changed as desired.

Although the invention has been described with respect to specific embodiments thereof, these embodiments are descriptive and not restrictive of the invention. For example, it should be apparent that the specific values and ranges of the parameters could vary from those described herein.

Although terms such as ‘data storage device’, ‘disk drive’, etc., are used, any type of storage unit can be adapted for use with the present invention. For example, disk drives, magnetic drives, etc., can also be used. Different present and future storage technologies can be used, such as those created with magnetic, solid-state, optical, bioelectric, nano-engineered or other techniques.

Storage units can be located either internally inside a computer or outside it in a separate housing that is connected to the computer. Storage units, controllers and other components of systems discussed herein can be included at a single location or separated at different locations. Such components can be interconnected by any suitable means, such as networks, communication links or other technology. Although specific functionality may be discussed as operating at or residing in or with specific places and times, in general, it can be provided at different locations and times. For example, functionality such as data protection steps can be provided at different tiers of a hierarchical controller. Although specific arrangements or storage system designs such as RAID have been discussed, other embodiments can use any other type of arrangement or configuration. For example, some features may work with standalone computer systems, some independently accessed drives, or even a single drive that may have separate partitions or other data-grouping organizations.

Note that any type of user input device can be used to convey signals to a processor executing the functions of the media management system for accessing the web hierarchy. For example, a mouse and pointer, trackball, touch screen, digitizing tablet, etc., can all be used. Dedicated controls, such as on a portable computing device, cell phone, e.g., numeric keypad, remote control, etc., can all be used as input devices. Moreover, any manner of indicators or on-screen controls, such as buttons, radio buttons, sliders, windows, dials, menus, etc., can be used. Different organizations and layouts of information can also be used, as desired.

In the description herein, numerous specific details are provided, such as examples of components and/or methods, to provide a thorough understanding of the embodiments. One skilled in the relevant art will recognize, however, that an embodiment of the invention can be practiced without one or more of the specific details, or with other apparatuses, systems, assemblies, methods, components, materials, parts, and/or the like. In other instances, well-known structures, materials or operations are not specifically shown or described in detail, to avoid obscuring aspects of the embodiments of the present invention.

Reference throughout this specification to ‘one embodiment’, ‘an embodiment’, or ‘a specific embodiment’ means that a particular feature, structure or characteristic, described in connection with the embodiment is included in at least one embodiment and not necessarily in all the embodiments. Therefore, the use of these phrases in various places throughout the specification does not imply that they necessarily refer to the same embodiment. Further, the particular features, structures or characteristics of any specific embodiment of the present invention may be combined in any suitable manner with one or more other embodiments. It is to be understood that other variations and modifications of the embodiments of the present invention, described and illustrated herein, are possible in light of the teachings herein, and are to be considered as part of the spirit and scope of the present invention.

It will also be appreciated that one or more of the elements depicted in the drawings/figures can also be implemented in a more separated or integrated manner, or even removed or rendered inoperable in certain cases, as is required, in accordance with a particular application. It is also within the spirit and scope of the present invention to implement a program or code that can be stored in a machine-readable medium, to permit a computer to perform any of the methods described above.

As used in the description herein and throughout the claims that follow, ‘a’, ‘an’, and ‘the’ includes plural references, unless the context clearly dictates otherwise. In addition, as used in the description herein and throughout the claims that follow, the meaning of ‘in’ includes ‘in’ and ‘on’, unless the context clearly dictates otherwise.

The foregoing description of the illustrated embodiments, including what is described in the Abstract, is not intended to be exhaustive or limit the invention to the precise forms disclosed herein. While specific embodiments and examples of the invention are described herein for illustrative purposes only, various equivalent modifications are possible within the spirit and scope of the present invention, as those skilled in the relevant art will recognize and appreciate. As indicated, these modifications may be made to the present invention, in light of the foregoing description of the illustrated embodiments, and are to be included within the spirit and scope of the present invention.

Therefore, while the present invention has been described herein with reference to the particular embodiments thereof, latitude of modification, various changes and substitutions are intended in the foregoing disclosures. It will be appreciated that in some instances, some features of the embodiments of the invention will be employed without the corresponding use of the other features, without departing from the scope and spirit of the invention, as set forth. Therefore, many modifications may be made, to adapt a particular situation or material to the essential scope and spirit of the present invention. It is intended that the invention is not limited to the particular terms used in the following claims and/or to the particular embodiment disclosed as the best mode contemplated for implementing the invention, which may include any and all the embodiments and equivalents falling within the scope of the appended claims.

What is claimed is:

1. A method for managing web content linked in a hierarchy according to a web page structure, the method comprising:
determining when a first web content is accessed, wherein the first web content is stored in a first storage medium;
determining second web content that is linked to the first web content in the hierarchy, the second web content being accessible through a web page including the first web content;
determining a second storage medium that is storing the second web content; and
powering up the second storage medium from a lower power mode of operation to a power mode of operation that is higher than the lower power mode such that the second web content can be accessed from the second storage medium quicker than if the second storage medium remained in the lower power mode of operation if a portion of the second web content is requested.

2. The method of claim 1, wherein the power mode of operation that is higher than the lower power mode comprises a powered on mode.

3. The method of claim 1, wherein the second web content is one or more levels below the first web content in the hierarchy.

4. The method of claim 3, wherein the first web content needs to be accessed before the second web content is accessible.

5. The method of claim 1, further comprising:
determining which web content is not below the first web content based on the hierarchy; and
powering down one or more third storage medium to a lower power level if the one or more third storage medium is not below the first web content.

6. The method of claim 1, further comprising:
determining which web content is a plurality of levels away from the first web content in the hierarchy; and
powering down one or more third storage medium to a lower power level if the one or more third storage medium is the plurality of levels away from the first web content in the hierarchy.

7. The method of claim 1, further comprising:
determining how many levels of a third web content is accessible from the first web content within a time period; and
powering up one or more third storage medium from the lower power mode of operation to a power mode of operation that is higher than the lower power mode such that the third web content can be accessible quicker than if the second storage medium remained in the lower power mode of operation if a portion of the third web content is requested.

8. The method of claim 7, wherein determining how many levels of the third web content is accessible from the first web content within the time period is based on a power up time that it takes the one or more storage medium to power up from the lower power mode of operation to the power mode of operation that is higher than the lower power mode.

9. The method of claim 7, further comprising caching the third web content.

10. The method of claim 7, wherein the second storage medium is in an ‘always on’ mode and the third storage medium is in a powered off state.

11. The method of claim 1, wherein the second storage medium is in a Redundant Array of Independent Volumes (RAIV).

12. The method of claim 1, further comprising accessing the second web content without moving the second web content to another storage medium.

13. The method of claim 1, further comprising adapting web content stored in a storage system based on changes in the web page structure.

14. A storage system for managing web content linked in a hierarchy according to a web page structure, the storage system comprising:
a first storage medium controller for determining when a first web content is accessed, wherein the first web content is stored in a first storage medium;
a second storage medium controller for determining second web content that is linked to the first web content in the hierarchy, the second web content being accessible through a web page including the first web content;
a power manager coupled to the first storage medium controller and the second storage medium controller for powering up the second storage medium from a lower power mode of operation to a power mode of operation that is higher than the lower power mode such that the second web content can be accessed from the second storage medium quicker than if the second storage medium remained in the lower power mode of operation if a portion of the second web content is requested.

15. The storage system of claim 14 further comprising a third storage medium controller capable of determining which web content is not below the first web content based on the hierarchy.

16. The storage system of claim 15, wherein the third storage medium controller is further capable of determining which web content is a plurality of levels away from the first web content in the hierarchy.

17. The storage system of claim 16, wherein the power manager is further capable of powering down the third storage medium to a lower power level if the third storage medium is the plurality of levels away from the first web content in the hierarchy.

18. The storage system of claim 15, wherein the power manager is further capable of powering down the third storage medium to a lower power level if the third storage medium not below the first web content based on the hierarchy.

19. The storage system of claim 15, wherein the third storage medium controller is further capable of determining how many levels of a third web content is accessible from the first web content within a time period.

20. The storage system of claim 15, wherein the power manager is further capable of powering up the third storage medium from the lower power mode of operation to a power mode of operation that is higher than the lower power mode when a portion of a third web content is accessible from the first web content within a time period.

21. The storage system of claim 14, wherein the second storage medium is in a Redundant Array of Independent Volumes (RAIV).
